(19) United States
(12) Patent Application Publication
(10) Pub. No.: US 2011/0147404 A1
(43) Pub. Date: Jun. 23, 2011

(54) LIDS FOR BOTTLES SUCH AS VIALS, AND KITS WITH LIDS

(76) Inventor: Dudley R. Dobie, III, Georgetown, TX (US)

(21) Appl. No.: 12/945,271

(22) Filed: Nov. 12, 2010

Related U.S. Application Data
(60) Provisional application No. 61/261,116, filed on Nov. 13, 2009.

(51) Int. Cl. B65G 59/00

(52) U.S. Cl. 221/306; 221/303

(57) ABSTRACT

Lids for bottles such as pill vials, bottles such as pill vials comprising a lid with a funnel, and kits comprising a plurality of lids and/or a plurality of bottles such as pill vials.

### CROSS-REFERENCE TO RELATED APPLICATIONS

This application claims priority to U.S. Provisional Patent Application No. 61/261,116, filed Nov. 13, 2009, which is incorporated by reference here in its entirety.

### BACKGROUND

1. Field of the Invention

The present invention relates generally to lids for bottles and vials. More particularly, but not by way of limitation, the present invention relates to lids for pill vials and other bottles (and vials and bottles with such lids) that facilitate controlled dispensing or dispensation of items from within the vials and bottles.

2. Background Information

A number of lids for vials and other bottles have been developed in the past to facilitate dispensation of pills or other items from within such vials and bottles. For example, U.S. Design Pat. No. D391,757 discloses a medicinal container having a funnel. By way of another example, U.S. Pat. No. 7,240,795 discloses a compartmented pill dispenser with a cap that can be rotated to align an opening to dispense pills from any one of the compartments. By way of another example, U.S. Pat. No. 7,147,130 discloses a pill dispensing system with a cap for a bottle/vial to facilitate dispensing of a single pill.

### SUMMARY

The present disclosure includes embodiments of lids for pill vials (e.g., prescription vials) and/or other bottles, kits comprising multiple such lids, vials and other bottles having such lids, and methods of use.

Some embodiments of the present lids for a pill vial, comprise: a body defining an opening and a funnel, the body configured to be coupled to a pill vial, and the funnel having an inner surface defining an open channel having a tip portion with a substantially constant width along its length. In some embodiments, the channel also has a base portion adjacent the tip portion, the base portion having a varying width that narrows along the length of the base portion toward the tip portion. In some embodiments, the funnel has a protrusion extending along the inner surface transverse to a longitudinal axis of the channel. In some embodiments, the protrusion is disposed between the base portion and the tip portion of channel.

Some embodiments further comprise: an inner member configured to be removably coupled to a pill vial such that the inner member is in fixed relation to the pill vial, and movably coupled to the body; where the body is configured to be movably coupled to the inner member such that the body can be moved relative to the inner member to cover the opening in predetermined increments. In some embodiments, the body is coupled to the inner member such that the body can rotate relative to the inner member to cover at least a portion of the opening. In some embodiments, one of the body and inner member includes a plurality of indents, the other of the body and the inner member includes a tab positioned to correspond with the plurality of indents, and the tab and indents cooperate to define the predetermined increments.

Some embodiments further comprise: a cover member movably coupled to the body; where the lid is configured such that the cover member can be moved relative to the body to cover the opening. In some embodiments, the cover member is coupled to the body such that the cover member can rotate relative to the body. In some embodiments, the lid is configured such that the movement of the cover member relative to the body is child resistant. In some embodiments, the lid is configured such that movement of the cover member relative to the body requires the application of forces in at least two different directions. In some embodiments, the lid is configured such that the cover member can be moved relative to the body to cover the opening in predetermined increments. In some embodiments, the cover member is coupled to the body such that the cover member can rotate relative to the inner member to cover at least a portion of the opening. In some embodiments, one of the body and cover member includes a plurality of indents, the other of the body and the cover member includes a tab positioned to correspond with the plurality of indents, and the tab and indents cooperate to define the predetermined increments.

Some embodiments further comprise: an inner member configured to be removably coupled to a pill vial in fixed relation to the pill vial, and rotatably coupled to the body; and a cover member rotatably coupled to the body; where the lid is configured such that the cover member can be moved relative to the body to cover the opening; where the body is configured to be movably coupled to the inner member such that the body can be moved relative to the inner member to cover the opening in predetermined increments; and where, if the body is rotatably coupled to the inner member, and the cover member is rotatably coupled to the body, then the cover member and the inner member must be rotated in opposite directions relative to the body to uncover the opening.

Some embodiments of the present lids for a pill vial, comprise: a body defining an opening and a two-stage funnel, the body configured to be coupled to a pill vial, and the funnel portion having an internal surface defining a channel with a base portion having a width that varies along the length of the base portion, and a tip portion having width that varies less along the length of the tip portion than the width of the base portion varies along the length of the base portion.

Some embodiments of the present lids for pill vial comprise: a body defining an opening, a funnel, and a tip portion, the body configured to be coupled to a pill vial, the funnel including a base end, a distal end, and an inner surface defining an open channel having a width that tapers between the base end and the distal end, the tip portion extending from the distal end of the funnel.

Some embodiments of the present kits comprise: a plurality of any of the present lids for a pill vial; where at least one of the plurality of lids is configured to have an appearance different from the appearance of at least one other of the plurality of lids. In some embodiments, the plurality of lids are different colors. In some embodiments, the plurality of lids are each marked with letters indicative of a different day of the week. In some embodiments, the plurality of lids are each marked with letters indicative of the name of a medication.

Some embodiments of the present lids for a bottle, comprise: a body defining an opening and a funnel, the body configured to be coupled to a bottle, and the funnel having an inner surface defining an open channel having a tip portion with a substantially constant width along its length. In some embodiments, the channel also has a base portion adjacent the tip portion, the base portion having a varying width that narrows along the length of the base portion toward the tip portion. In some embodiments, the funnel has a protrusion extending along the inner surface transverse to a longitudinal axis of the channel. In some embodiments, the protrusion is disposed between the base portion and the tip portion of channel.

Some embodiments further comprise: an inner member configured to be removably coupled to a bottle such that the inner member is in fixed relation to the bottle, and movably coupled to the body; where the body is configured to be movably coupled to the inner member such that the body can be moved relative to the inner member to cover the opening in predetermined increments. In some embodiments, the body is coupled to the inner member such that the body can rotate relative to the inner member to cover at least a portion of the opening. In some embodiments, one of the body and inner member includes a plurality of indents, the other of the body and the inner member includes a tab positioned to correspond with the plurality of indents, and the tab and indents cooperate to define the predetermined increments.

Some embodiments further comprise: a cover member movably coupled to the body; where the lid is configured such that the cover member can be moved relative to the body to cover the opening. In some embodiments, the cover member is coupled to the body such that the cover member can rotate relative to the body. In some embodiments, the lid is configured such that the movement of the cover member relative to the body is child resistant. In some embodiments, the lid is configured such that movement of the cover member relative to the body requires the application of forces in at least two different directions. In some embodiments, the lid is configured such that the cover member can be moved relative to the body to cover the opening in predetermined increments. In some embodiments, the cover member is coupled to the body such that the cover member can rotate relative to the inner member to cover at least a portion of the opening. In some embodiments, one of the body and cover member includes a plurality of indents, the other of the body and the cover member includes a tab positioned to correspond with the plurality of indents, and the tab and indents cooperate to define the predetermined increments.

Some embodiments further comprise: an inner member configured to be removably coupled to a bottle such that the inner member is in fixed relation to the bottle, and rotatably coupled to the body; and a cover member rotatably coupled to the body; where the lid is configured such that the cover member can be moved relative to the body to cover the opening; where the body is configured to be movably coupled to the inner member such that the body can be moved relative to the inner member to cover the opening in predetermined increments; and where, if the body is rotatably coupled to the inner member, and the cover member is rotatably coupled to the body, then the cover member and the inner member must be rotated in opposite directions relative to the body to uncover the opening.

Some embodiments of the present lids for a bottle comprise: a body defining an opening and a two-stage funnel, the body configured to be coupled to a bottle, and the funnel portion having an internal surface defining a channel with a base portion having a width that varies along the length of the base portion, and a tip portion having width that varies less along the length of the tip portion than the width of the base portion varies along the length of the base portion.

Some embodiments of the present lids for a pill vial comprise: a body defining an opening, a funnel, and a tip portion, the body configured to be coupled to a pill vial, the funnel including a base end, a distal end, and an inner surface defining an open channel having a width that tapers between the base end and the distal end, the tip portion extending from the distal end of the funnel.

Some embodiments of the present kits comprise: a plurality of any of the present lids for a bottle; where at least one of the plurality of lids is configured to have an appearance different from the appearance of at least one other of the plurality of lids. In some embodiments, the plurality of lids are different colors. In some embodiments, the plurality of lids are each marked with letters indicative of a different characteristic of the contents of a bottle.

Any embodiment of any of the present lids, kits, and/or methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 depicts a perspective view of one of the present lids coupled to a vial.

FIG. 2 depicts a perspective view of the lid of FIG. 1 in a closed configuration.

FIG. 3 depicts a perspective view of the lid of FIG. 1 in a partially open configuration.

FIG. 4 depicts a perspective view of the lid of FIG. 1 in a fully open configuration.

FIG. 5 depicts a perspective view of the lid and vial of FIG. 1.

FIG. 6 depicts an exploded perspective view of the lid and vial of FIG. 1.

FIG. 7 depicts a perspective view of an inner member of the lid of FIG. 1.

FIG. 8 depicts a bottom perspective view of a body or outer member of the lid of FIG. 1.

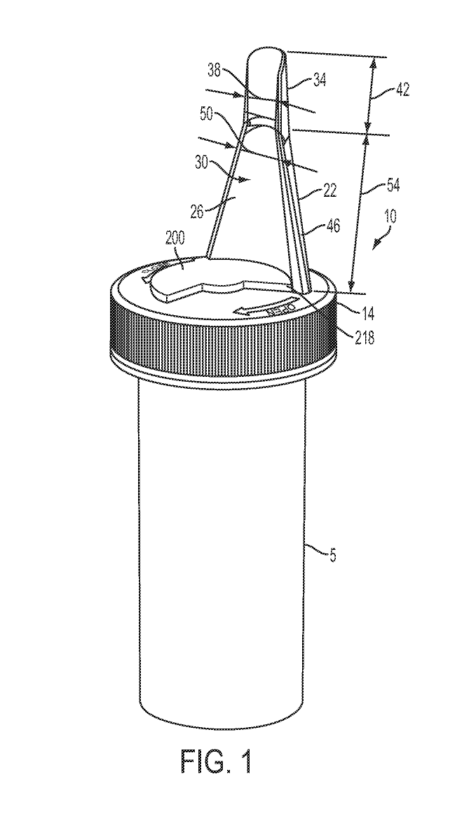

### DESCRIPTION OF ILLUSTRATIVE EMBODIMENTS

The term “coupled” is defined as connected, although not necessarily directly, and not necessarily mechanically; two items that are “coupled” may be integral with each other. The terms “a” and “an” are defined as one or more unless this disclosure explicitly requires otherwise. The terms “substantially,” “approximately,” and “about” are defined as largely but not necessarily wholly what is specified, as understood by a person of ordinary skill in the art.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method that “comprises,” “has,” “includes” or “contains” one or more steps possesses those one or more steps, but is not limited to possessing only those one or more steps. Likewise, a lid that “comprises,” “has,” “includes” or “contains” one or more elements possesses those one or more elements, but is not limited to possessing only those elements. For example, in a lid that comprises a body and an inner member, the lid includes the specified elements but is not limited to having only those elements. For example, such a lid could also include a cover member.

Further, a device or structure that is configured in a certain way is configured in at least that way, but it can also be configured in other ways than those specifically described.

Referring now to the drawings, shown therein and designated by the reference numeral 10 is one of the present lids for a bottle (e.g., a pill vial 5). In the embodiment shown, lid 10 comprises a body 14 defining an opening 18 and a funnel 22; and lid 10 is configured to be coupled (e.g., removably coupled) to vial 5. In the embodiment shown, lid 10 is configured to be coupled to (and is shown coupled to) an industry standard 8-dram prescription medication vial 5, and is further configured to assist and/or enable a user to dispense pills in a controlled fashion from vial 5 (e.g., into a secondary pill container such as a weekly pill case). In other embodiments, lid 10 can be: configured to be coupled to nearly any type of bottle, and/or configured for dispensing nearly any type of item(s) that may be dispensed from a bottle (e.g., screws, nails, nuts, bolts, arts and crafts supplies, food spices, jewelry beads). Funnel 22 is configured to assist with dispensing pills or other items from vial 5, such as, for example, by providing a path for pills to travel as they exit vial 5, such that pills or other items exiting vial 5 can be dispensed in a controlled direction (e.g., into a small compartments of a weekly pill organizer case).

Additionally, in the embodiment shown, funnel 22 has an inner surface 26 defining an open channel 30 having a tip portion 34 with a substantially constant width 38 (measured to inner surface 26 on each side of channel 30) along its length 42 (e.g., having a substantially constant width of equal to, less than, greater than, or between any of 1, 2, 3, 4, 5, 6, 7, 8, 9, 10, or more millimeters). In embodiments in which tip portion 34 of funnel 22 has a hemispherical cross-section, width 38 is also the diameter of the hemispherical cross-section. In the embodiment shown, funnel 22 is further configured such that channel 30 has a base portion 46 adjacent to tip portion 34 (e.g., base portion 46 is between tip portion 34 and vial 5 when body 14 is coupled to vial 5, as shown), the base portion (46) having a varying width 50 (measured to inner surface 26 on each side of channel 30) that narrows along the length 54 of base portion 46 in a direction toward tip portion 34 (e.g., in a direction from vial 5 toward tip portion 34 when body 14 is coupled to vial 5, as shown). In embodiments in which base portion 46 of funnel 22 has a hemispherical cross-section, width 50 is also the diameter of the hemispherical cross-section. In the embodiment shown, base portion 46 has a width 50 that is widest adjacent opening 18 and that narrows as base portion 46 approaches tip portion 34 (e.g., such that width 50 of base portion 46 is substantially equal to width 38 of tip portion 34 at the point where base portion 46 and tip portion 34 meet). In the embodiment shown, funnel 22 is of unitary construction with body 14, such that body 14 comprises a single piece having base portion 46 and tip portion 34. In the embodiment shown, widths 38 and 50 are measured perpendicular to the central, longitudinal axis of channel 22.

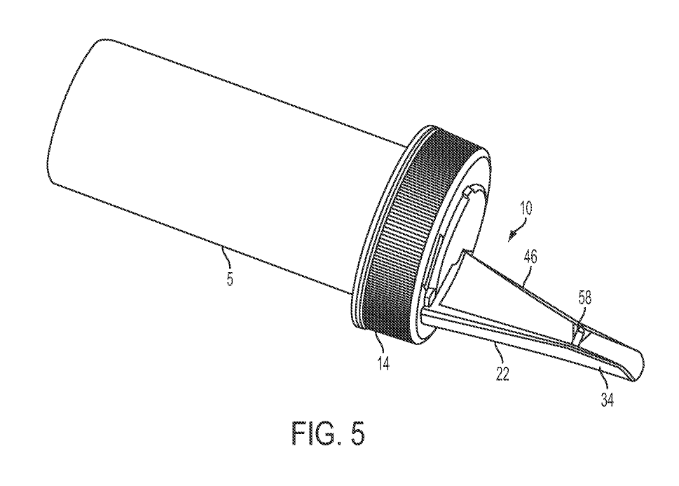

Additionally, in the embodiment shown, funnel 22 has a protrusion 58 extending along the inner surface 26 of funnel 22 (e.g., transverse to a longitudinal axis of channel 30, such as perpendicular to length 54 and length 42 of base portion 46 and tip portion 34, respectively). In the embodiment shown, protrusion 58 is disposed between base portion 46 and tip portion 34. Protrusion 58 extends outwardly from inner surface 26 (and inwardly into the open channel of funnel 22) to provide a “speed bump” or mechanical impediment to slow item such as pills as they are dispensed from vial 5 (e.g., to slow and/or stop pills such that pills can be dispensed in a desired fashion). For example, protrusion 58 is configured to assist user in dispensing only a desired number of pills or other items from vial 5, such as, for example, when vial 5 is in a tilted orientation such as that shown in FIG. 5. In the embodiment shown, protrusion 58 comprises an arch-shaped band (e.g., with an arcuate cross-section having a radius of curvature of equal to, less than, greater than, or between any of 0.1, 0.2, 0.3, 0.4, 0.5, 0.6, 0.7, 0.8, 0.9, and/or 1 millimeter). In other embodiments, protrusion 58 can have any other suitable configuration that protrudes from the inner surface 26 of the channel 30 (e.g., from inner surface 26 of tip portion 34 to assist or enable a user to control pill dispensing from vial 5).

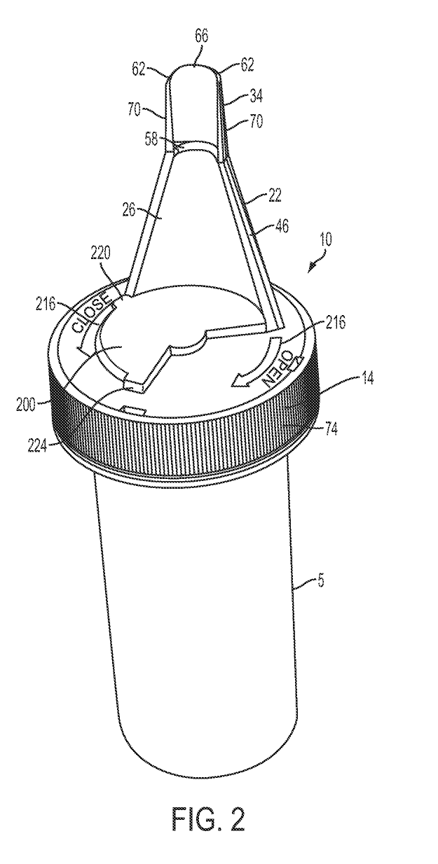

The relatively narrower tip portion 34 permits tip portion 34 to be fit or extended into other containers (e.g., secondary pill containers, such as tray) such that if too many items are dispensed from bottle or vial 5, tip portion 34 can be extended into secondary container to retrieve excess items disposed from bottle or vial 5. In the embodiment shown (and shown clearly in FIG. 2), tip portion 34 of funnel 22 is further provided with rounded edges 62 between end 66 and lateral edges 70 of tip portion 34. Further, in the embodiment shown tip portion 34 is provided with a tapered end such that the thickness of the sidewall of funnel 22 tapers to a minimum thickness at the tip 66 and/or along curved rounded edges 62 of tip portion 34. In the embodiment shown, body 14 further comprises an outer knurled surface 74 (e.g., around a peripheral edge, surface, or boundary of body 14, as shown) with a ribbed texture to assist or improve a user's grip on body 14, such as when rotating body 14 relative to vial 5.

In the embodiment shown, lid 10 further comprises an inner member 100 having an opening 102 corresponding in size and shape to opening 18 of body 14; the inner member (100) being configured to be removably coupled to bottle or vial 5 (e.g., by way of tabs, notches, thread(s), and/or other coupling or attachment structure(s) 104 of bottle or vial 5) such that inner member 100 is in fixed relation to bottle or vial 5, and movably coupled to body 14. More particularly, inner member 100 is provided with a corresponding structure (e.g., tabs, thread(s), or the like) such that to couple inner member 100 to vial 5, inner member 100 is simply slid over vial 5, pressed down slightly, and rotated in a clockwise fashion (similar to a standard cap for vial 5); and can be removed from vial 5 by pressing down slightly and rotating inner member 100 in a counterclockwise direction. In other embodiments, opening 18 can be of any suitable size or shape. In the embodiments shown, body 14 is configured to be movably coupled to inner member 100 such that body 14 can be moved relative to inner member 100 to cover opening 18 in predetermined increments (e.g., configured to make the usable size of opening 18 adjustable for different sizes of pills, and for limiting the flow of pills from vial 5). In the embodiment shown, inner member 100 comprises an opening 102 generally corresponding in size and shape to opening 18 of body 14. As such, when opening 102 is aligned with opening 18, opening 18 is substantially open or unobstructed such that items can pass from vial 5 through opening 18 and into funnel 22, and when opening 102 is not aligned with opening 18, inner member 100 at least partially blocks or covers opening 18.

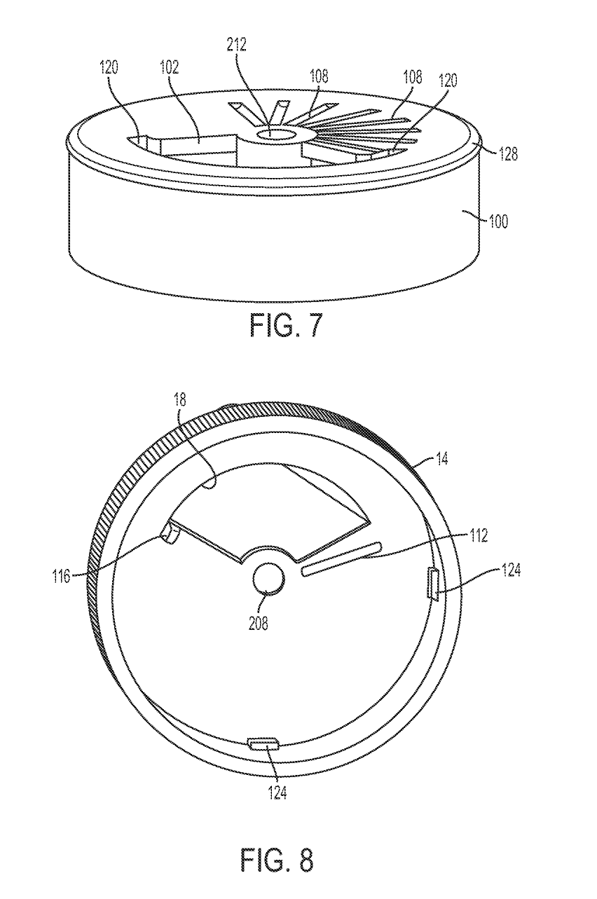

More particularly, in the embodiment shown, body 14 is coupled to inner member 100 such that body 14 can rotate (e.g., around an axis extending longitudinally through the center of the bottle and inner member 100) relative to inner member 100 to cover at least a portion of opening 18. For example, in some embodiments, one of body 14 and inner member 100 includes a plurality of indents, and the other of body 14 and inner member 100 includes a tab positioned to correspond with the plurality of indents such that the tab and indents cooperate to define the predetermined increments. In the embodiment shown, inner member 100 comprises a plurality of indents 108 (as shown in more detail in FIG. 7), and body 14 includes a tab 112 (as shown in more detail in FIG. 8) positioned to correspond with indents 108 such that when body 14 and inner member 100 are assembled, tab 112 extends into one of indents 108 at a time and can be moved between sequential indents 108 such that body 14 and inner member 100 cooperate to define the predetermined increments at which inner member 100 cooperates with body 14 to cover opening 18. In the embodiment shown, body 14 further comprises a stop tab 116, and inner member 100 defines notches 120, such that when body 14 is coupled to inner member 100, stop tab 116 extends at least partially into opening 102 such that stop tab 116 and notches 120 cooperate to limit the range of rotation between body 14 and inner member 100 between a fully open position in which opening 18 is aligned with opening 102 and a fully closed position in which inner member 100 fully covers or impedes opening 18. In the embodiment shown, body 14 comprises one or more guide members 124 (e.g., three guide members 124 at equiangular intervals around body 14) configured to snap over or otherwise engage a ridge or lip 128 of inner member 100, such that body 14 can be pressed over inner member 100 and guide members 124 will snap over ridge 128 to resist separation of body 14 from inner member 100 while permitting rotation of body 14 relative to inner member 100.

Although described in terms of inner member 100 covering opening 18, it will be apparent from the description in this disclosure that “cover” does not necessarily imply a top and bottom relationship. For example, although inner member 100 will generally be recognized as below body 14 (e.g., using bottle or vial 5 as a reference), inner member 100 is described in this disclosure as covering opening 18. Rather, as used in this disclosure, “cover” references one part, component, portion, or the like covering, blocking, or impeding an opening (e.g., opening 18) at least partially (e.g., so as to reduce the usable size of the opening), such as by preventing a pill or other item from passing through or being able to pass through the opening.

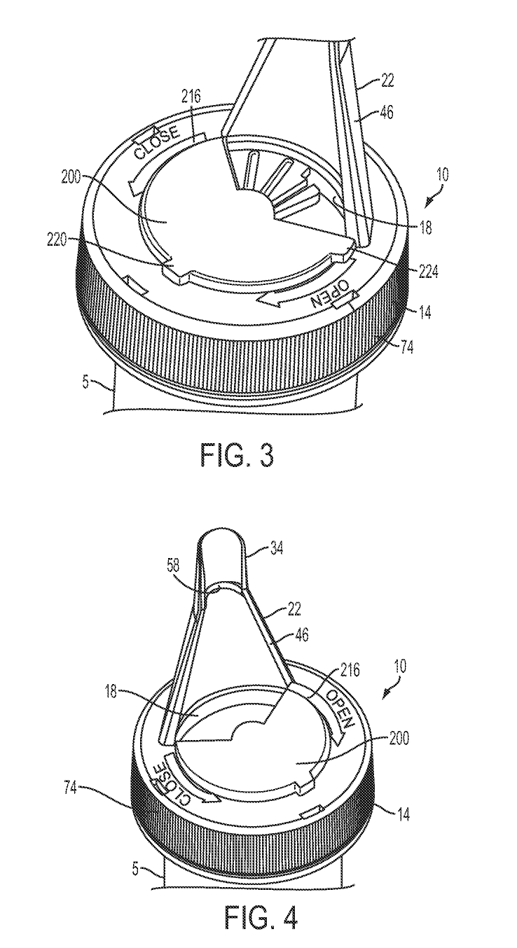

In the embodiment shown, lid 10 further comprises a cover member 200 movably coupled to body 14, where lid 10 is configured such that cover member 200 can be moved relative to body 14 to cover opening 18. More particularly, in the embodiment shown, cover member 200 is coupled to body 14 such that cover member 200 can rotate relative to body 14. In the embodiment shown, cover member 200 includes a post 204 configured to extend through a central opening 208 of body 14 and a central opening 212 of inner member 100 such that cover member 200, body 14, and inner member 100 are each rotatably coupled to one another. Further, in the embodiment shown, lid 10 is configured such that movement of cover member 200 relative to body 14 is child resistant (e.g., such that forces in at least two different directions are required to uncover opening 18 and access the contents of bottle or vial 5). More particularly, and as indicated by arrows 216 in FIGS. 3 and 4, to uncover opening 18 in the embodiment of lid 10 shown, cover member 200 must be rotated in a counterclockwise direction relative to body 14, and body 14 must be rotated in a clockwise direction relative to bottle or vial 5.

Additionally, cover member 200 can comprise a tab 218 configured such that when cover member 200 is rotated fully clockwise relative to body 14, as shown, tab 218 catches on funnel 22 to resist a counterclockwise rotation of cover member 200 relative to body 14, such that at least a minimal force is required to cause tab 218 to flex sufficiently to permit cover member 200 to rotate counterclockwise to uncover or open opening 18. Cover member 200 can also comprise tab 220 configured to prevent cover member 200 from rotating clockwise beyond a certain point relative to body 14 (e.g., the point where tab 220 engages funnel 22, as shown in FIG. 2); and/or cover member 200 can comprise tab 224 configured to prevent cover member 200 from rotating counterclockwise beyond a certain point relative to body 14 (e.g., the point where tab 224 engages funnel 22, as shown in FIG. 3). In some embodiments cover member 200 can be configured to have one or more tabs (not shown) extending from the lower surface of cover member 200 toward body 14 and/or inner member 100, and/or one or more of body 14 and inner member 100 can be configured to include notches corresponding to such a tab on cover member 200, such that cover member 200 can be moved (e.g., rotated) relative to body 14 to cover opening 18 in predetermined increments.

In this way, lid 10 comprises: body 14; inner member 100 configured to be movably coupled to pill vial 5 in fixed relation to pill vial 5 and rotatably coupled to body 14; and cover member 200 rotatably coupled to body 14; where lid 10 is configured such that cover member 200 can be moved relative to body 14 to cover opening 18; where body 14 is configured to be movably coupled to inner member 100 such that body 14 can be moved relative to inner member 100 and cover opening 18 in predetermined increments; and where, if body 14 is rotatably coupled to inner member 100, and cover member 200 is rotatably coupled to body 14, cover member 200, and inner member 100 must be rotated in opposite directions relative to body 14 to uncover opening 18.

In some embodiments, lid 10 comprises: a body 14 defining opening 18 and a two-stage funnel 22, where body 14 is configured to be coupled to a pill vial 5. Funnel 22 has an internal surface 26 defining a channel 30 with base portion 46 having a width 50 that varies along length 54 of the base portion 46, and tip portion 34 having width 38 that is constant along length 42 or varies less along length 42 of tip portion 34 than width 50 varies along length 54 of base portion 46. Stated another way, width 50 varies along length 54 more than width 38 varies along length 42 (e.g., width 38 may not vary along length 42). For example, in the embodiment shown, width 38 is substantially constant along length 42. In other embodiments, however, width 38 varies in proportion to length 34 in a smaller amount than width 50 varies in proportion to length 54. In some embodiments, the distal end (shown farthest from vial 5) may be partially or entirely closed such that open channel 30 is open on its side along the length of funnel 22, but the distal end of tip portion is closed such that tip portion 34 forms a scoop with a closed end.

Variation in widths 38 and/or 50 can be measured absolutely and/or proportionally. In the present embodiments, width 38 of tip portion 34 is always less than or equal to the smallest width 50 of base portion 46 such that width 38 may vary less proportionately and/or absolutely along length 42 than width 50 varies along length 54. For example, width 38 might be equal to 10 mm at the widest end of tip portion 34, and equal to 8 mm at the narrowest end of tip portion 34; and width 50 might be equal to 10 mm at the narrowest end of base portion 46, and equal to 25 mm at the widest end of base portion 46 such that width 38 varies proportionally by 25% (of the widest width, 10 mm) which is less than the proportional variation of width 50 (60% of the widest width, 25 mm); and such that width 38 varies absolutely by 2 mm, which is less than the absolute variation of width 50 (15 mm).

In some embodiments (not shown), the lid comprises: a body defining an opening (e.g., opening 18), a funnel, and a tip portion, where the body is configured to be coupled to a bottle or vial 5). In such embodiments, the funnel can include base portion 46 of funnel 22. For example, the funnel can include a base end (e.g., adjacent the opening) and a distal end (similar to end of base portion 46 that is adjacent tip portion 34), and an inner surface 26 defining an open channel 30 having a width 50 that tapers between the base end and the distal end. In such embodiments, the tip portion of the lid may not form a part of the open channel of the funnel. For example, in such embodiments, the tip portion can comprise a flat or spoon-shaped extension from the distal end of the funnel (e.g., with similar length and/or width as tip portion 34 shown, but not necessarily continuing open channel 30 or otherwise forming a channel).

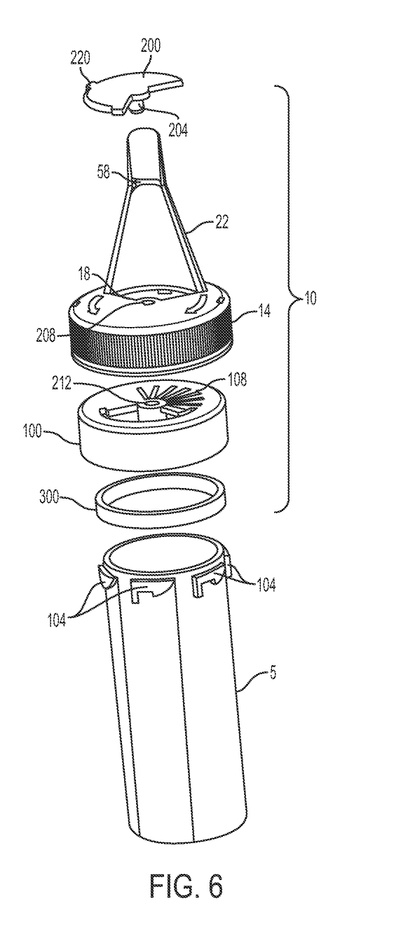

In the embodiment shown, lid 10 further comprises an O-ring 300 configured to fit between inner member 100 and vial 5, as indicated in FIG. 6, to substantially seal the interface between vial 5 and inner member 100, and/or to provide an additional bias against removal of inner member 100 from vial 5 (e.g., such that it takes a greater downward pressure on inner member 100 relative to vial 5 to permit rotation and removal of inner member 100 from vial 5, such as, for example, for child-resistance or resistance to being opened by a child). In other embodiments, body 14 can be configured to be directly coupled to a bottle or vial 5 (e.g., to attachment structure 104), such that inner member 100 can be omitted and cover member 200 can be the sole structure for covering opening 18.

Components of lid 10 can comprise any suitable materials, such as, for example, plastics, polymers, and the like. For example, body 14, inner member 100, and/or cover member 200 can comprise polypropylene (PP). PP is a thermoplastic material that is naturally translucent, and can be formulated to have improved clarity. PP is generally a tough, impact-resistant material with moderate stiffness (tensile strength). PP can be readily colored in nearly any color. Components of lid 10 can also be manufactured or formed by any suitable process. For example, components of lid 10 can be formed by injection molding.

Some embodiments of the present kits comprise: a plurality of any of the present lids 10. Not all lids 10 in a given kit necessarily have the same configuration or features. In some embodiments of the present kits, at least one of the plurality of lids 10 is configured to have an appearance different from the appearance of at least one other of the plurality of lids 10. In some embodiments, each of the plurality of lids 10 is configured to have an appearance different from the appearance of each of the other plurality of lids 10. For example, in some embodiments, each of the plurality of lids 10 is a different color (e.g., red, blue, green, and the like). By way of another example, in some embodiments, each of the plurality of lids 10 is marked with letters indicative of a different day of the week (e.g., M or Monday, T or Tuesday, W or Wednesday, and/or the like), such as, for example, in a kit comprising seven lids 10, each marked for different day of the week. By way of another example, in some embodiments, the plurality of lids 10 are each marked with letters indicative of the name of a medication (e.g., penicillin, acetaminophen, and/or like). Such differences in appearance of lids 10 can enable faster and/or more-reliable differentiation between lids 10, their corresponding bottles 5, and ultimately, the medication or other items disposed in bottles or vials 5.

Embodiments of the present bottles comprise a bottle or similar container and one of the present lids 10 configured to be coupled with a bottle. For example, in some embodiments, the present bottle comprises a pill vial 5 (e.g., 8-dram, 16-dram, and/or any other suitable size pill vial) and one of the present lids 10 configured to be coupled to the vial. In other embodiments, the present pill bottle comprises a pill vial and one of the present lids 10 coupled to the vial. In any of the various embodiments, the bottle can comprise any suitable attachment structure 104 (e.g., tabs, threads, and/or the like), as discussed above.

The various illustrative embodiments of lids and kits described herein are not intended to be limited to the particular forms disclosed. Rather, they include all modifications and alternatives falling within the scope of the claims. For example, although the embodiment of inner member 100 shown in FIG. 7 includes eight indents 108, other embodiments can comprise any suitable number of indents 108, such as, for example, two, three, four, five, six, seven, nine, ten, or more.

The claims are not intended to include, and should not be interpreted to include, means-plus- or step-plus-function limitations, unless such a limitation is explicitly recited in a given claim using the phrase(s) “means for” or “step for,” respectively.

1. A lid for a pill vial, comprising:
a body defining an opening and a funnel, the body configured to be coupled to a pill vial, and the funnel having an inner surface defining an open channel having a tip portion with a substantially constant width along its length.

2. The lid of claim 1, where the channel also has a base portion adjacent the tip portion, the base portion having a varying width that narrows along the length of the base portion toward the tip portion.

3. The lid of claim 2, where the funnel has a protrusion extending along the inner surface transverse to a longitudinal axis of the channel.

4. The lid of claim 3, where the protrusion is disposed between the base portion and the tip portion of channel.

5. The lid of claim 1, further comprising:
an inner member configured to be removably coupled to a pill vial such that the inner member is in fixed relation to the pill vial, and movably coupled to the body;
where the body is configured to be movably coupled to the inner member such that the body can be moved relative to the inner member to cover the opening in predetermined increments.

6. The lid of claim 5, where the body is coupled to the inner member such that the body can rotate relative to the inner member to cover at least a portion of the opening.

7. The lid of claim 6, where one of the body and inner member includes a plurality of indents, the other of the body and the inner member includes a tab positioned to correspond with the plurality of indents, and the tab and indents cooperate to define the predetermined increments.

8. The lid of claim 1, further comprising:
a cover member movably coupled to the body;
where the lid is configured such that the cover member can be moved relative to the body to cover the opening.

9. The lid of claim 8, where the cover member is coupled to the body such that the cover member can rotate relative to the body.

10. The lid of claim 9, where the lid is configured such that the movement of the cover member relative to the body is child resistant.

11. The lid of claim 10, where the lid is configured such that movement of the cover member relative to the body requires the application of forces in at least two different directions.

12. The lid of claim 11, where the lid is configured such that the cover member can be moved relative to the body to cover the opening in predetermined increments.

13. The lid of claim 12, where the cover member is coupled to the body such that the cover member can rotate relative to the inner member to cover at least a portion of the opening.

14. The lid of claim 13, where one of the body and cover member includes a plurality of indents, the other of the body and the cover member includes a tab positioned to correspond with the plurality of indents, and the tab and indents cooperate to define the predetermined increments.

15. The lid of claim 1, further comprising:
an inner member configured to be removably coupled to a pill vial in fixed relation to the pill vial, and rotatably coupled to the body;
a cover member rotatably coupled to the body;
where the lid is configured such that the cover member can be moved relative to the body to cover the opening;
where the body is configured to be movably coupled to the inner member such that the body can be moved relative to the inner member to cover the opening in predetermined increments; and
where, if the body is rotatably coupled to the inner member, and the cover member is rotatably coupled to the body, then the cover member and the inner member must be rotated in opposite directions relative to the body to uncover the opening.

16. A lid for a pill vial, comprising:
a body defining an opening and a two-stage funnel, the body configured to be coupled to a pill vial, and the funnel portion having an internal surface defining a channel with a base portion having a width that varies along the length of the base portion, and a tip portion having width that varies less along the length of the tip portion than the width of the base portion varies along the length of the base portion.

17. A lid for a pill vial, comprising:
a body defining an opening, a funnel, and a tip portion, the body configured to be coupled to a pill vial, the funnel including a base end, a distal end, and an inner surface defining an open channel having a width that tapers between the base end and the distal end, the tip portion extending from the distal end of the funnel.

18. A kit comprising:
a plurality of the lids of claim 1;
where at least one of the plurality of lids is configured to have an appearance different from the appearance of at least one other of the plurality of lids.

19. The kit of claim 18, where the plurality of lids are different colors.

20. The kit of claim 18, where the plurality of lids are each marked with letters indicative of a different day of the week.

21. The kit of any of claims 18-20, where the plurality of lids are each marked with letters indicative of the name of a medication.

22-41. (canceled)
